(19) United States
(12) Patent Application Publication
(10) Pub. No.: US 2026/0117136 A1
(43) Pub. Date: Apr. 30, 2026

(54) METHOD AND APPARATUS FOR MARKING A LIQUID HYDROCARBON IN A RESERVOIR

(71) Applicant: SICPA HOLDING SA, Prilly (CH)

(72) Inventor: Edmund HALASZ, Orbe (CH)

(21) Appl. No.: 18/994,458

(22) PCT Filed: Aug. 9, 2023
(86) PCT No.: PCT/EP2023/071989

§ 371 Date: Jan. 14, 2025

(30) Foreign Application Priority Data
Aug. 15, 2022 (EP) 22190415.4

(51) Int. Cl. C10L 1/10

(52) U.S. Cl. CPC C10L 1/10; C10L 2230/16

(57) ABSTRACT

The present invention relates to a method for homogeneous marking of petroleum hydrocarbon stored within a reservoir on a vehicle with at least one marker. The method comprises inserting a loading arm comprising a marker injection conduit having a free end being operative to dispense a pulsating, pressurised marker stream and a gas injection conduit having a free end being operative to dispense a pulsating, pressurised gas stream into a reservoir of a vehicle. The method further comprises positioning the free end of the marker injection conduit at a marker height from a lowest surface of the reservoir and the free end of the gas injection conduit at a gas height from a lowest surface of the reservoir within petroleum hydrocarbon within the reservoir, wherein the free end of the marker injection conduit is located at the marker height which is larger than the gas height.

The present invention relates to a method and an apparatus for homogeneous marking of petroleum hydrocarbon stored within a reservoir on a vehicle with a marker solution comprising at least one marker.

### BACKGROUND OF INVENTION

Marking of petroleum hydrocarbons with the scope of auditing the custody transfer of such products and the compliance to the tax excise, to prevent and/or prove theft and/or counterfeiting is of great importance for the petroleum industry. In addition, marking of petroleum hydrocarbons may be also used to control whether a distributor has sold a low-priced petroleum hydrocarbon as a more expensive petroleum hydrocarbon or has used a low-priced petroleum hydrocarbon to dilute a more expensive petroleum hydrocarbon. Accordingly, methods for determining authenticity and adulteration of chemically marked petroleum hydrocarbons have been developed for detecting and quantifying markers of said petroleum hydrocarbons to satisfy the high demand from government bodies and the petroleum industry.

Additionally, national governments are interested in technical solutions that allow to determine whether applicable taxes have been paid on petroleum hydrocarbons, whether tax exempt petroleum hydrocarbons are being sold as tax paid petroleum hydrocarbons or if they are being used to dilute tax paid petroleum hydrocarbons, and whether a petroleum hydrocarbon, which meets environmentally mandated specifications has been diluted with a product that does not meet such specifications.

Manual marking of petroleum hydrocarbons is conventionally achieved by dispensing a marker solution into petroleum hydrocarbon contained within a petroleum hydrocarbon compartment of petroleum hydrocarbon transportation vehicles (for example trucks) which consist of explosive atmospheres and environments. These marker solutions usually contain one or more markers, specific solvents and stabilizing substances, allowing to produce solutions that can be dosed in easily measurable values, usually from 10 to 50 ml for 1000 l of fuels and have long shelf times. The marker solutions are subsequently mixed within the petroleum hydrocarbon by turbulences as a results of accelerations and decelerations during transportation. Other phenomena enabling mixing, such as diffusion are time consuming and cannot be taken into considerations for practical operations. In some countries testing, in particular quality control testing, of the marked petroleum hydrocarbon is required immediately after marking of the petroleum hydrocarbon with the at least one marker solution. As such, the conventional methods of marking the petroleum hydrocarbon will fail as no additional energy is provided to the system fuel and marker, hence the marker not being homogeneously dispersed within the petroleum hydrocarbon.

There is therefore a need for a cost-effective and efficient method and apparatus for providing homogeneous marking of petroleum hydrocarbons stored within petroleum hydrocarbon transportation vehicles, especially in explosive atmospheres and environments.

### SUMMARY OF INVENTION

According to a first aspect of the present invention, there is provided a method for homogeneous marking of petroleum hydrocarbon stored within a reservoir on a vehicle, preferably a truck, with a marking solution comprising at least one marker, the method comprising:
inserting a loading arm (5) into the reservoir of the vehicle, said loading arm (5) comprising a marker injection conduit (6) having a free end (9a) being operative to dispense a pressurised marker stream, preferably a pulsating, pressurised marker stream, and a gas injection conduit (7) having a free end (9b) being operative to dispense a pressurised gas stream, preferably a pulsating, pressurised gas stream;
positioning within the petroleum hydrocarbon within the reservoir the free end (9a) of the marker injection conduit (6) at a marker height from a lowest surface of the reservoir (11a) and positioning the free end (9b) of the gas injection conduit (7) at a gas height from the lowest surface of the reservoir (11a), wherein the free end (9a) of the marker injection conduit (6) is located at the marker height which is larger than the gas height; and
simultaneously dispensing the pressurised marker stream and the pressurised gas stream into the petroleum hydrocarbon.

The pressurised marker stream, preferably the pulsating, pressurised marker stream and the pressurised gas stream, preferably the pulsating, pressurised gas stream are dispersed in a controlled manner.

Preferably, the marker injection conduit (6) and the gas injection conduit (7) are in direct contact, more preferably said marker injection conduit (6) and said gas injection conduit (7) are mechanically bonded.

The two feed streams (marker stream and gas stream) are separate, and the role of the gas is to create bubbles that, by moving and expanding up to the free surface of the petroleum hydrocarbon, will create turbulences, thus enabling a rapid and efficient dispersion of the marker into the petroleum hydrocarbon.

The method described herein allows the homogeneous dispersion of the at least one marker of the marker solution into petroleum hydrocarbons stored in explosive atmospheres and environments such as vehicles.

According to a second aspect of the present invention, there is provided an apparatus for homogeneous marking of petroleum hydrocarbon stored within a reservoir on a vehicle, preferably a truck, with a marker solution comprising at least one marker, the apparatus comprising:
a loading arm (5),
a marker solution feed source (3) comprising a pressurised marker feed, preferably a pulsating, pressurised marker stream,
a pressurized gas feed source (4)
a marker injection conduit (6) having a first end (8a) in communication with the marker solution feed source (3) comprising the pressurised marker feed stream to receive a feed stream therefrom and an opposed second free end (9a) configured to dispense the pressurised marker in the petroleum hydrocarbon, and
a gas injection conduit (7) having a first end (8b) in communication with the pressurized gas feed source (4) comprising the pressurised gas feed stream to receive a feed stream therefrom and an opposed second free end (9b) configured to dispense the pressurised gas in the petroleum hydrocarbon.

As known by the man skilled in the art, the free end (9a) of marker injection conduit (6) and the free end (9b) of the gas injection conduit (7) independently comprise an actuated valve to allow the pressurized stream to exit and to prevent the fuel to enter along the corresponding conduit.

The term “pulsating, pressurised marker feed stream” is used herein to refer to a pressurised marker solution stream, wherein the marker solution is delivered in volume controlled and measured pulses through a specific hardware.

Markers are conventionally added to petroleum hydrocarbon either prior to loading the petroleum hydrocarbon onto a truck or once the petroleum hydrocarbon has already been loaded onto the truck (known as onboard addition). The present invention relates to a method and apparatus for onboard addition of at least one marker to a petroleum hydrocarbon carried on a vehicle such as a tanker, with several compartments. The marking process preferably occurs in each compartment, separately.

The petroleum hydrocarbon is preferably selected from the group consisting of gasolines, diesel fuels, kerosenes, heating oils, heating fuel oils, and combinations thereof. The addition of the at least one marker is also referred to herein as marking.

In one embodiment, the petroleum hydrocarbon is loaded into the reservoir before dispensing of the pressurised marker feed stream and of the pressurised gas feed stream into the reservoir. Preferably, the petroleum hydrocarbon is loaded into the reservoir before inserting the loading arm, the marker injection conduit and the gas injection conduit into the reservoir The at least one marker of the marker solution is miscible in and compatible with the petroleum hydrocarbon which is to be marked. A typical example of said at least one marker is a halogenated marker such as those described in EP 1 392 146 B1. The quantity, for example quantity and/or flow rate of the marker solution introduced into the pressurised marker stream, preferably into the pulsating, pressurised marker stream, may be automated. The apparatus may for example comprise a controller operable to control the quantity and/or flow rate of the marking solution comprising the at least one marker introduced into the pressurised gas stream.

The vehicle may be any suitable vehicle. Preferably, the reservoir is a tank compartment. Preferably, the vehicle is a truck, for example a top-loading truck (i.e. a truck in which access to the reservoir is provided from the top of the reservoir). The vehicle is preferably a petroleum hydrocarbon transportation truck.

The loading arm (also referred in the art as “lance”) has a first end and a second end and is preferably operable to be inserted through a top hatch of the reservoir of the vehicle. The loading arm may be provided on a mobile frame. The loading arm may for example be articulated (i.e. may comprise at least one articulated joint). An articulated joint may be provided between the first and second ends of the loading arm, and may for example be substantially centrally located therebetween.

The position of the loading arm relative to the reservoir may be manually adjustable. In one embodiment, the position of the loading arm relative to the reservoir may be automated. The apparatus may comprise a controller operable to adjust the position of the loading arm (for example the second end thereof). The apparatus may for example further comprise a depth adjustment mechanism configured to determine the location of the loading arm also including the location of the second end of said loading arm.

As shown in FIG. 1A, the marker injection conduit 6 has a first end 8a and a free end 9a and the gas injection conduit 7 has a first end 8b and a free end 9b. The free end 9b of the gas injection conduit 7 may be a single free end or may be a multiple free ends with nozzles.

The free end 9a of the marker injection conduit 6 is positioned at a marker height from the lowest surface of the reservoir 11a and the free end 9b of the gas injection conduit 7 is positioned at a gas height from the lowest surface of the reservoir 11a, wherein the free end 9a of the marker injection conduit (6) is located at the marker height which is larger than the gas height.

The distance 10a between the free end 9a of the marker injection conduit 6 within the petroleum hydrocarbon and the lowest surface of the reservoir 11a is larger than the distance 10b between the free end 9b of the gas injection conduit 7 within the petroleum hydrocarbon and the lowest surface of the reservoir 11a, i.e. 10a>10b, such that gas bubbles interact with the marker, that first will descend, dues to the injection pressure.

As shown in FIGS. 1A and 1B, the free end 9a of the marker injection conduit 6 has a lowest surface (corresponding to the upper line of 10a) and the free end 9b of the gas injection conduit 7 has a lowest surface (corresponding to the upper line of 10b), wherein the lowest surface of the free end 9a of the marker injection conduit 6 is placed on top of the lowest surface of the free end 9b of the gas injection conduit 7.

As shown in FIG. 1A, the lowest surface of free end 9a of the marker injection conduit 6 is separated from the lowest surface of the free end 9b of the gas injection conduit 7 by a distance 10c, wherein said distance 10c is preferably at least 10%, more preferably at least 20%, of the distance 10a.

As shown in FIG. 1A, the reservoir has a height 11, which corresponds to the distance between its upmost surface 11b and its lowest surface 11a. Preferably, the distance 10b between the free end 9b of the gas injection conduit 7 within the petroleum hydrocarbon and the lowest surface of the reservoir (11a) is between about 20% and 50% of the height 11 of the reservoir, more preferably between about 20% and 40%.

The apparatus described herein is grounded to avoid static charges build-up and electrical discharges.

In one embodiment, the pressurised marker feed stream, preferably the pulsating, pressurised marker stream, and the pressurised gas feed stream, preferably the pulsating, pressurised gas stream, comprise pressurised air. The pressurised gas is preferably a pressurised air. It is however to be understood that the gas may comprise any suitable mixture of gases, preferably, the gas comprises a mixture of non-flammable gases.

The hydrostatic pressure of the petroleum hydrocarbon should be overcome by the injection of the marker stream at at least 0.2 or 0.3 bars and the gas stream at at least 0.2 or 0.3 bar The pressurised marker stream, preferably the pulsating, pressurised marker stream, has preferably a pressure of at least 2 bars and the pressurised gas stream, preferably the pulsating, pressurised gas stream, has preferably a pressure of at least 2 bars.

The flow rate of the pressurised marker feed stream, preferably the pulsating, pressurised marker stream is preferably at least about 0.5 L/min, for example about 1 L/min.

In one embodiment shown in FIG. 1B, the pressurised marker feed stream, preferably the pulsating pressurised marker feed stream is dispersed by a propeller preferably operated by a pneumatic motor or compressed air engine.

In one embodiment, the apparatus further comprises a controller operable to control the duration of and/or time periods between each pulse of the pressurised marker feed stream and between each pulse of the pressurised gas feed stream.

The apparatus may comprise a controller operable to control the quantity and/or flow rate of the marker solution comprising the at least one marker and the marker feed stream in order to provide a predetermined dose to the petroleum hydrocarbon.

The apparatus may for example comprise an air compressor operable at up to about 6 bars.

The apparatus may further comprise at least one deflector configured to increase turbulence of the pressurised marker feed stream and of the pressurised gas feed stream. The at least one deflector may be located within the loading arm or located at or adjacent the second free end thereof.

Dispensation of the marking solution comprising the at least one marker into the reservoir using the method and apparatus of the present invention provide effective turbulences within the petroleum hydrocarbon stored within the reservoir. The introduction of the pressurised feed streams, preferably the pulsating, pressurised streams, into the petroleum hydrocarbon results in the generation of bubbles. The bubbles rapidly randomly distribute within the petroleum hydrocarbon. At large Reynolds number, the bubble produced experience an agitation that can combine shear-induced turbulence (SIT), large-scale buoyancy-driven flows, and bubble induced agitation (BIA). Such turbulences provide for rapid homogenisation of the marker of within the petroleum hydrocarbon. As such, the marked petroleum hydrocarbon provided by the method and apparatus of the present invention complies with the immediate post-marking testing (such as for example quality control testing) required in some countries.

The present invention provides for a cost-effective and efficient method of marking of petroleum hydrocarbons with the at least one marker in the marker solution allowing doses of 10 to 50 millilitres for 1000 litres of petroleum hydrocarbons, in particular marking of petroleum hydrocarbon with at least one marker, without substantially increasing the time periods required for marking of the petroleum hydrocarbons and detrimentally effecting transportation schedules.

Embodiments of the present invention will now be discussed in more detail in relation to the accompanying Figures:

### BRIEF DESCRIPTION OF FIGURES

FIGS. 1A and 1B are schematic cross-sectional views of the apparatus according to two embodiments of the present invention.

### DETAILED DESCRIPTION

The following definitions are to be used to interpret the meaning of the terms discussed in the description and recited in the claims.

As used herein, the article “a/an” indicates one as well as more than one and does not necessarily limit its referent noun to the singular.

As used herein, the term “about” means that the amount or value in question may be the specific value designated or some other value in its neighbourhood. Generally, the term “about” denoting a certain value is intended to denote a range within ±5% of the value. As one example, the phrase “about 100” denotes a range of 100±5, i.e. the range from 95 to 105. Preferably, the range denoted by the term “about” denotes a range within ±3% of the value, more preferably ±1 %. Generally, when the term “about” is used, it can be expected that similar results or effects according to the invention can be obtained within a range of ±5% of the indicated value.

As used herein, the term “and/or” means that either all or only one of the elements of said group may be present. For example, “A and/or B” means “only A, or only B, or both A and B”. In the case of “only A”, the term also covers the possibility that B is absent, i.e. “only A, but not B”.

The term “comprising” as used herein is intended to be non-exclusive and open-ended. Thus, for instance a solution comprising a compound A may include other compounds besides A. However, the term “comprising” also covers, as a particular embodiment thereof, the more restrictive meanings of “consisting essentially of” and “consisting of”, so that for instance “a solution comprising A, B and optionally C” may also (essentially) consist of A and B, or (essentially) consist of A, B and C.

Where the present description refers to “preferred” embodiments/features, combinations of these “preferred” embodiments/features are also deemed to be disclosed as long as the specific combination of “preferred” embodiments/features is technically meaningful.

With reference to the Figures, the apparatus 1 comprises a feed source 2 comprising a marker solution feed source 3 and a pressurized gas feed source 4. The feed source 2 comprises the marker solution feed source 3 capable of retaining a volume typically of between 20 to 50 litres of the marker solution.

The apparatus 1 further comprises a loading arm 5 comprising a first end in communication preferably through a flexible tubing with the feed source 2 to receive a feed stream comprising the marker solution, and an opposed second free end configured to dispense the at least one marker therethrough. The loading arm 5 is mounted on a mobile frame (not shown) or connected to a flexible tubing.

The marker injection conduit 6 comprises a first end 8a and a free end 9a and the gas injection conduit 7 comprises a first end 8b and a free end 9b. The distance 10a between the free end 9a of the marker injection conduit 6 within the petroleum hydrocarbon and the lowest surface of the reservoir (11a) is larger than the distance 10b between the free end 9b of the gas injection conduit 7 within the petroleum hydrocarbon and the lowest surface of the reservoir 11a, i.e. 10a >10b.

Preferably, the lowest surface of free end 9a of the marker injection conduit 6 is separated from the lowest surface of the free end 9b of the gas injection conduit 7 by a distance 10c, wherein said distance 10c is preferably at least about 10%, more preferably at least about 20%, of the distance 10a.

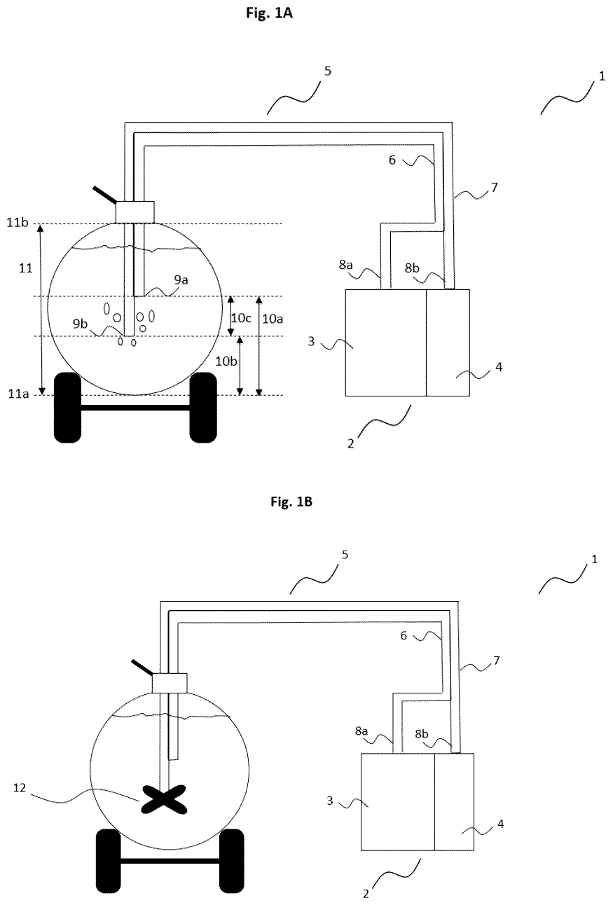

As shown in FIG. 1A,, the reservoir has a height 11, which corresponds to the distance between its upmost surface 11b and its lowest surface 11a. Preferably, the distance 10b between the free end 9b of the gas injection conduit 7 within the petroleum hydrocarbon and the lowest surface of the reservoir 11a is between about 20% and about 50% of the height 11 of the reservoir, more preferably between about 20% and about 40%.

The loading arm 5 may be articulated and comprises articulated joints which are configured to enable the second free end of the loading arm 5 to be moved freely relative to the first end for ease of loading into a reservoir or tank of a vehicle and to accommodate variations in dimensions between vehicles. It is to be understood that the loading arm may comprise any suitable number of articulated joints or may in some embodiments not have any articulated joints. It is to be understood that the loading arm 5 may be located in a fixed position without articulation. However, flexible tubing offers higher freedom to operate.

The apparatus 1 may further comprise a controller (not shown) operable to control the duration of and/or time periods between each pulse of the pulsating, pressurised marker feed stream and the pulsating, pressurised gas feed stream.

Once in position, the compressed air engine is operated to supply a pressurised gas feed stream, preferably a pulsating, pressurised gas stream, from the pressurized gas feed source 4 along the loading arm 5. Preferably, the pulsating, pressurised marker feed stream is supplied using a pressurising pump at a pressure of at least about 2 bars and with a flow rate of about 1 L/min. A controller may be operated to select predetermined flow rates and/or pressures of the pressurised marker feed stream, preferably the pulsating, pressurised marker stream.

The present invention provides a method and apparatus for accurately dispensing a predetermined dose to the petroleum hydrocarbon. Simultaneously dispensation of the pressurised marker feed stream, preferably the pulsating, pressurised marker stream, and of the pressurised gas feed stream, preferably the pulsating, pressurised gas stream, into the reservoir using the method and apparatus of the present invention provides rapid and effective turbulences within the petroleum hydrocarbon stored within the reservoir. The pressurised pulsation of the gas feed stream results in the generation of bubbles which rapidly and randomly distribute within the petroleum hydrocarbon. At large Reynolds number, the bubble produced experience an agitation that can combine shear-induced turbulence (SIT), large-scale buoyancy-driven flows, and bubble induced agitation (BIA). As such, the marker dosed petroleum hydrocarbon provided by the method and apparatus of the present invention complies with the immediate post-marking testing (such as for example quality control testing) required in some countries without extending the marking time period or introducing the use of expensive machinery.

1. A method for homogeneous marking of petroleum hydrocarbon stored within a reservoir on a vehicle, with a marking solution comprising at least one marker, the method comprising:
inserting a loading arm into the reservoir of the vehicle, said loading arm comprising a marker injection conduit having a free end being operative to dispense a pressurised marker stream, and a gas injection conduit having a free end being operative to dispense a pressurised gas stream;
positioning within the petroleum hydrocarbon within the reservoir the free end of the marker injection conduit at a marker height from a lowest surface of the reservoir and positioning the free end of the gas injection conduit at a gas height from the lowest surface of the reservoir, wherein the free end of the marker injection conduit is located at the marker height which is larger than the gas height; and
simultaneously dispensing the pressurised marker stream and the pressurised gas stream into the petroleum hydrocarbon.

2. The method according to claim 1, wherein the pressurised marker stream is a pulsating, pressurised marker stream and wherein the pressurised gas stream is a pulsating, pressurised gas stream.

3. The method according to claim 1, wherein the marker injection conduit and the gas injection conduit are in direct contact.

4. The method according to claim 3, wherein the marker injection conduit and the gas injection conduit are mechanically bonded.

5. The method according to claim 1, wherein the petroleum hydrocarbon is selected from the group consisting of gasolines, diesel fuels, kerosenes, heating oils, heating fuel oils and combinations thereof.

6. The method according to claim 1, wherein the reservoir is a tank compartment.

7. The method according to claim 1, wherein the loading arm, the marker injection conduit and the gas injection conduit are inserted through a top hatch of the reservoir of the vehicle.

8. The method according to claim 1, wherein the petroleum hydrocarbon is loaded into the reservoir before dispensing of the pressurised marker feed stream and the pressurised gas feed stream into the reservoir.

9. The method according to claim 1, wherein the petroleum hydrocarbon is loaded into the reservoir before inserting the loading arm, the marker injection conduit and the gas injection conduit.

10. The method according to claim 1, wherein the pressurised marker feed stream is dispersed by a propeller operated by a pneumatic motor or compressed air engine.

11. An apparatus for homogeneous marking of petroleum hydrocarbon stored within a reservoir on a vehicle, with a marker solution comprising at least one marker, the apparatus comprising:
a loading arm,
a marker solution feed source comprising a pressurised marker feed,
a pressurized gas feed source comprising a pressurised gas feed,
a marker injection conduit having a first end in communication with the marker solution feed source comprising the pressurised marker feed stream to receive a feed stream therefrom and an opposed second free end configured to dispense the pressurised marker in the petroleum hydrocarbon, and
a gas injection conduit having a first end in communication with the pressurized gas feed source comprising the pressurised gas feed stream to receive a feed stream therefrom and an opposed second free end configured to dispense the pressurised gas in the petroleum hydrocarbon.

12. The apparatus according to claim 11, wherein the pressurised marker stream is a pulsating, pressurised marker stream and wherein the pressurised gas stream is a pulsating, pressurised gas stream

13. The apparatus according to claim 11, wherein the marker injection conduit and the gas injection conduit are in direct contact, and wherein a lowest surface of the free end of the marker injection conduit is placed on top of a lowest surface of the free end of the gas injection conduit.

14. The apparatus according to claim 11, wherein the loading arm is operable to be inserted through a top hatch of the reservoir of the vehicle.

15. The apparatus according to claim 12, further comprising a controller operable to control the duration of and/or time periods between each pulse of the pressurised marker feed stream and of the pressurised gas feed stream.

16. The method according to claim 1, wherein the vehicle is a truck.

17. The apparatus according to claim 11, wherein the vehicle is a truck.

18. The apparatus according to claim 13, wherein the marker injection conduit and the gas injection conduit are mechanically bonded.
